(19) United States
(12) Patent Application Publication
(10) Pub. No.: US 2011/0023359 A1
(43) Pub. Date: Feb. 3, 2011

(54) AEROPONIC GROWING APPARATUS AND METHOD

(76) Inventor: David Raring, Vancouver, WA (US)

Correspondence Address: Thomas & Karceski, P.C., 536 GRANITE AVENUE, RICHMOND, VA, 23226, US

(21) Appl. No.: 12/834,243

(22) Filed: Jul. 12, 2010

Related U.S. Application Data
(60) Provisional application No. 61/229,541, filed on Jul. 29, 2009.

(51) Int. Cl. A01G 31/02

(52) U.S. Cl. 47/62 A

(57) ABSTRACT

Apparatus and method for improving aeroponic horticulture growing efficiency by delivering air and atomized liquid nutrient to plant roots in a manner that preserves and encourages root hair growth. The disclosed aeroponic system includes a nozzle for varying the particle size distribution and flow rate of an atomized liquid nutrient. In one embodiment, a significant portion of the atomized liquid droplets are less than 30 microns in size.

This application claims the benefit of Provisional Application No. 61/229,541, filed Jul. 29, 2009.

### FIELD OF THE DISCLOSURE

The present disclosure relates generally to an apparatus and method for cultivating plants without soil. More specifically, the apparatus and method(s) disclosed herein supply plant roots with air and liquid nutrients where the liquid is atomized into a cloud of droplets of a small particle size generally under 30 microns diameter. The subject system also provides a relatively wide particle size distribution, and the specific droplet size and size distribution can be tailored for specific applications. In one embodiment, the droplets are produced via a sonic nozzle. Surprisingly, and contrary to conventional wisdom, the subject disclosure results in dramatically improved plant growth.

### BACKGROUND OF THE DISCLOSURE

The cultivation of a plant or plants using any form of nutrient solutions without soil is known as hydroponics. In a hydroponic system, the plant absorbs nutrients through its roots when the roots are submerged in the nutrient solution. The roots may be continuously or intermittently submerged for feeding. Overall, hydroponics is widely used in commercial agriculture because it increases crop yields and can be practiced in an artificial environment year-round.

Hydroponic conditions, however, are not ideal for plants. For instance, the presence of fertilizer and high humidity stimulates the growth of salmonella and/or plant pathogens. In a multiple plant hydroponic system, the circulation of the nutrient solution can spread those pathogens or diseases from plant to plant. The submersion time of the roots is also critical, and hydroponics often leads to the overwatering (and subsequent damage) of plants. Commercially, there are high infrastructure costs associated with attempting to overcome these disadvantages.

It is also known that hydroponic growing damages the very delicate “root hairs”, which are a special form of rhizoid. These hairs are very fragile structures that grow outward from a single epidermal cell and are generally only one cell in diameter. The presence of root hair dramatically increases the available surface area of the root to process nutrients and air. However, the fluid with nutrients flowing through a hydroponic system, as is required to fill, drain, or otherwise circulate fluids, is known to abrade and wash away root hairs. New ‘hairs’ may not be able to form in a hydroponic environment.

While the function of root hair is not thoroughly understood, it is thought that they are responsible for much of a plant's nutrient and liquid uptake. Ongoing studies in this area indicate a relationship between the growth rate of plants and the health and abundance of root hair.

In contrast to hydroponic systems, aeroponic systems continuously expose plant roots to an environment saturated with drops (mist or fog) comprising a nutrient solution. Water and nutrients in an aeroponic system are delivered to the plant roots via the process of impaction and agglomeration of the mist or fog droplets onto the roots and root hairs. It is thought that a portion of the roots should, at all times, be exposed to air so that nutrients and O₂ can be simultaneously absorbed into the plants.

The most common aeroponic systems use pressurized water that is sprayed onto the roots using simple garden sprinkler-type fluid nozzles. The resulting droplets are very large, generally in excess of 150 microns, resulting in water flowing along the roots and washing off existing hair while preventing new hair from forming. It is conventionally thought, as described in US Patent Application Publication No. 2009/02933557, that nutrient droplets in an aeroponic system should be at least 30 microns in size. The conventional wisdom is that droplets below 30 microns fail to achieve continuous aeroponic growth because such droplet sizes would have to be supplied in such a high concentration that liquid saturation would occur. Basically, it is conventionally thought that the extremely high droplet densities of these small droplet sizes (<30 microns) are necessary to support plant growth. The conventional thinking is that the high concentration of droplets would prevent enough air from getting to the roots, and without enough air, the roots would eventually die. Finally, it is conventionally thought that an effective aeroponic system or method must supply the root area with a simultaneous and continuous combination of air and liquid solution.

Technology is available to provide very small liquid droplets down to 1 micron. However, that technology utilizes a piezo electric device to produce the droplets. For aeroponics, piezoelectric atomizing devices produce a very narrow particle size distribution and fail to produce an adequate droplet size distribution. Piezoelectric atomizing devices/nozzles also fail to provide adequate kinetic energy to transport and distribute the droplets throughout the root chamber, and fail to supply adequate flow of liquid without operating continuously thus not allowing the root hair to function efficiently.

A potential failure of all previous aeroponic systems has been their vulnerability to bacterial and other diseases that cause crop failure or otherwise infect the plant. These diseases are typically caused by over warming of nutrient solutions such that the growth of bacteria and other pathogens is encouraged.

In summary, conventional aeroponic systems and methods present distinct shortcomings. There is a need for improved aeroponic apparatus and methods.

### SUMMARY OF THE DISCLOSURE

In accordance with the present disclosure, an improved aeroponic system is provided that leads to substantially improved biomass growth while reducing disease and bacterial growth. It has surprisingly been found, in contrast to conventional wisdom, that water droplets less than 30 microns provide significant benefits for plant growth. Moreover, it was surprisingly found that providing nutrient droplets over a broad particle size distribution so as to aeroponically deliver droplets that match a plant's “root hair” diameters (i.e., distribution of diameters for new/old hairs, different type pants, etc.) maximizes plant growth. It has also surprisingly been found that the subject particle size distribution reduces root damage and encourages agglomeration of droplets onto root hairs. Still further, it has surprisingly been found that continuous fog or droplet generation in an aeroponic system is not necessary to maximize plant growth. Instead, intermittent operation of a droplet-producing nozzle in an aeroponic system can encourage growth. Therefore, while continuous operation is possible, one embodiment of the subject system entails non-continuous operation of the system.

Broadly, the system disclosed herein includes certain benefits such as, but not limited to, 1) maintaining and encouraging increased root surface area, 2) more efficiently providing nutrients to the root surface area that is available than possible with known hydroponic and aeroponic systems, 3) optionally providing root hairs with an alternating wet/dry environment beneficial to plant degassing without starving other roots of moisture, and 4) preventing or reducing the incidences of plant disease relative to known systems.

The subject apparatus facilitates aeroponic-supported biomass growth via the careful control of aeroponic conditions. For instance, the subject system allows for the specific control of droplet particle size distribution over a broad range of saunter mean diameters from <1 to 50 or more microns. More specifically, in one embodiment, the use of a sonic nozzle in aeroponics, as disclosed herein, generates the broad particle size distribution that has surprisingly been found to maximize plant growth. A significant portion of the size distribution is below 30 microns. In another embodiment, the subject nozzle is not a piezoelectric nozzle. The subject nozzle is also not a nozzle as described in US Patent Application Publication No. 2009/0293357 A1. It has been found that droplets in the range of 5 to 30 microns are desirable and a relatively large particle size distribution is desirable. The nozzle disclosed in 2009/0293357 and piezoelectric nozzles do not supply the desired particle sizes or particle size distributions.

The subject system grows plants by supporting them on a platform above an aeroponic chamber where the lower stem and/or roots hang unconstrained in the chamber. A liquid reservoir or supply may or may not occupy the bottom portion of the aeroponic chamber but the walls and floor are continuously wet. The subject plant roots may never be in direct contact with a liquid bath through most or all of the plants' life cycle. However, it may be advantageous to have some percentage of the roots be in contact with a wetted surface from which the roots can absorb large volumes of liquid, particularly during a plant's late vegetation, blooming, and/or fruiting stages.

In an embodiment where the liquid resides at the bottom of the chamber, the flow rate and level of liquid in the chamber is controlled using automated valves and/or gravity feed as a means of maintaining a set temperature in the chamber. The liquid is circulated using a pump to a larger reservoir where its temperature and other characteristics are monitored and altered to match the requirements of the growing plants. The liquid might also be directly aspirated from the aeroponic chamber and reintroduced through the subject nozzle (i.e., a secondary reservoir is not necessary).

The subject aeroponic chamber is periodically filled with water droplets with a controlled particle size distribution appropriate and/or optimized for the particular plants being grown. Particle size distribution can be achieved over a range of about <1 to about 100 microns (or greater). It has surprisingly been found that the relatively large distribution of droplet particle sizes improves plant growth. It is thought that the droplets agglomerate to root fibers and root hairs having a diameter similar to the diameter of the droplets. As a growing plant continuously generates root hairs, there is a natural size distribution of root hairs (i.e., ‘old’ hairs and ‘new’ hairs). A significant percentage of the aeroponic droplets of the subject system are of a like particle size to the various diameters of the plant's root hair, generally less than 30 microns saunter mean diameters. Other droplets are larger so as to agglomerate to the roots themselves. The droplet particle size distribution as supplied by the system and nozzle as described herein best matches the root hair size distribution of a maturing plant.

It was determined, by various observations, that as roots grow in an aeroponic chamber, they become a dense mass of large and small diameter fibers that act like a filter to airborne droplets moving in the aeroponic chamber. Large droplets are more easily filtered by the larger diameter roots and have a hard time penetrating into the inner area of the root mass. Smaller droplets migrate more easily through the open space within the root mass finding their way to the roots and root hairs in the inner portion of the root mass providing their needed irrigation.

Again, it has been surprisingly discovered that very fine droplets in the 0-30 micron range are highly beneficial for root hair irrigation and for penetration of the dense root mass. It was also determined that a fraction of the total liquid spray should be presented as larger droplets that will wet the larger primary root system and provide adequate total volume of liquid to satisfy the plants total demand for liquid. The deeper, larger roots of plants are responsible for acquiring this excess liquid. In the aeroponic chamber of this disclosure, those roots may be allowed to attach to the walls and floor of the grow chamber so that the roots are constantly in contact with a film or a depth of liquid and never starved of moisture. The nozzle system of the subject system keeps those areas wet by producing a fraction of larger droplets that easily impact and deposit on the walls and floor of the root chamber.

In addition to producing a broad range of droplet sizes, the nozzle of the subject system imparts adequate kinetic energy into the root zone in the form of air movement resulting from the introduction of atomizing air at pressure to transport and distribute the droplets produced throughout the root chamber including within the root mass. The kinetic energy is required to move the droplets through the outer boundaries of the root ball so as to deposit the smaller droplets on the roots and root hairs of the centrally located plant roots.

In addition to producing the broad range of droplets and having adequate kinetic energy, the nozzle(s) of the subject system has a flow capacity adequate to provide all of the liquid needed by the roots contained within the root chamber when operated continuously or on a timed cycle, as has been found to be beneficial for aeroponic growing. It is surprisingly advantageous to feed the root hairs with small droplets and then rested for some period of time to allow them to absorb the nutrient and expel gasses produced internally by the plants. The exact on/off time cycle can vary for differing plants, for different stages of growth, and for the amount of root mass within the root chamber. For instance, a typical cycle for a tomato plant in foliage stage in an 18×18×18 aeroponic chamber of the subject system might be 10 minutes ‘off’ and 30 seconds ‘on’ while the subject nozzle operates at 25 PSIG air pressure and aspirates nutrient for a height/distance of 18″.

Most aeroponic systems currently available use low-pressure water sprays similar to those commonly used for soil garden watering. These nozzles produce only larger droplets that destroy root hair as droplets flow down the larger root strands. They do, however, provide adequate kinetic energy to distribute the liquid flow and they do provide adequate flow rate to satisfy the demand for liquid while operating on a timed cycle. Without healthy root hair, however, the plant cannot function as efficiently as it does with the system of this disclosure.

In one embodiment, the subject system creates a fog using a dual fluid sonic type nozzle that uses a compressed gas, such as air, to atomize liquid that is aspirated directly from the bath of nutrient rich liquid circulating through the bottom of the aeroponic chamber. In another embodiment, it is envisioned that the liquid might be aspirated from a central storage tank.

The compressed gas is accelerated to sonic velocity through a venturi in the core of the nozzle thereby creating sonic shockwaves at a frequency above that the human audible range. The shockwaves are reflected by a resonator thereby creating a standing wave pattern of sonic energy. Water is then delivered into a negative pressure region of the shockwave where it is “shattered” by the shock waves. By the subject nozzle and system, atomization of the liquid is more versatile and controllable than conventional atomization including atomization via piezoelectric nozzles. Smaller droplet sizes can be achieved relative to conventional aeroponic systems. At the same time, a broader distribution of droplet particle sizes can be achieved by the apparatus and methods disclosed herein relative to other techniques, such as piezoelectric techniques. The subject nozzle does not have any moving parts.

The fog created by the subject system is introduced to the root mass within one of a plurality of aeroponic chambers. In general, as noted above, it can be difficult for a fog to achieve good penetration of a root ball where the root mass is dense. That is, conventionally formed aeroponic droplets may not reach a significant portion of a plant's root's surface area. The subject dual fluid nozzle provides an advantage in that the compressed gas used to atomize the liquid carries the fog through the mass of roots. Relatively less airflow is required when the plant is young relative to when the plant is well developed. Overall, the subject dual fluid, sonic nozzle has a widely variable compressed air flow capability. The nozzle operating parameters can be adjusted to accommodate a specific plant's stages of growth.

As also noted above, the outer portion of the root bundle typically strips the air of the water droplets. The larger the droplets, the more the droplets are stripped or impinge against the outer roots. The outer boundary roots are less likely to collect relatively fine droplets, as contemplated by the subject apparatus relative to conventional aeroponic systems. Therefore, the relatively smaller droplet particle sizes of the subject system better penetrate the root ball. At the same time, the broad particle size distribution disclosed herein results in better droplet agglomeration to the root hairs. Therefore, the surface area of the available roots is maximized for nutrient intake.

The subject system also contemplates enriching the compressed gas with extra oxygen or other component to accelerate growth in certain plants. The atomizing gas can include a desired additive component.

The system can have many forms. For example, in one embodiment, the nozzle presents droplets directly into the root aeroponic chamber (i.e., “direct spray”). In another embodiment, the fog may first enter a fog chamber and then a portion of the generated fog would be delivered to the aeroponic chamber through one or more conduits that may or may not be fitted with fans. The fans would further control droplet size distribution or would assist in distributing the droplets into complex root structures.

In one direct spray embodiment, there may be provided top, side, and bottom mounted spray nozzles. Any number of nozzles may be employed to accommodate for the size of the aeroponic chamber, the age and thickness of the root bundles, the type of plant, atmospheric conditions, and the like. As such, the subject system will be provided in a range of sizes and configurations. It is also envisioned that modular arrangements for the system will be provided.

The subject is less prone to bacterial and other diseases by maintaining a relatively cool root environment relative to other aeroponic/hydroponic systems. The subject aeroponic chamber is insulated. The very fine liquid droplets intermittently sprayed through the subject nozzle enhance the cooling effect of liquid evaporation. In addition, temperature monitoring and cooling device may be employed to maintain a environment that protects against disease. Intermittent operation of the system provides some protection by allowing the fluid on the root hairs to be absorbed. Bacteria is more likely to grow in a continuously wet environment.

As a result of the customization of the subject system, home gardeners and hobbyists will benefit. Greenhouses and large-scale commercial ventures may also benefit. The subject system will use less water and nutrients than conventional hydroponics and aeroponics while/or maximizing growth over known systems. Use of the subject apparatus to provide smaller droplets will increase plant health and growth. As noted above, one embodiment envisions that the droplets are provided in the <1-50 micron saunter mean diameter range. In another embodiment, the droplets are provided in the <1 to 30 micron saunter mean diameter range. In yet another embodiment, the droplets of the subject aeroponic system comprise droplets in the <1-20 micron saunter mean diameter range.

While the above highlights particular features of the disclosure in order that the detailed description thereof may be better understood, and in order that the present contribution to the art may be better appreciated, there are additional features of the invention that will be described hereinafter. Also, it is to be understood that the phraseology and terminology employed herein are for the purpose of the description and should not be regarded as limiting.

### BRIEF DESCRIPTION OF THE DRAWINGS

The foregoing, and additional objects, features, and advantages of the present invention will become apparent to those of skill in the art from the following detailed description of a preferred embodiment thereof, taken in conjunction with the accompanying drawings, in which:

FIG. 1A is a schematic view of one embodiment of a multi-chamber aeroponic system of the present disclosure;

FIG. 1B is another schematic view of an embodiment of a multi-chamber aeroponic system in accordance with subject disclosure;

FIG. 2 is a schematic view of on chamber of an aeroponic system in accordance with the subject disclosure;

FIG. 3 is, a perspective view of one embodiment of an aeroponic chamber as disclosed herein; and

FIG. 4 is a cut away view of a sonic nozzle as employed by the subject system.

### DETAILED DESCRIPTION OF THE APPLICATION

As will be described in detail herein, the subject apparatus and method can improve the delivery of nutrients, water and/or oxygen to a plant in an aeroponic system by providing relatively small droplet particle sizes. In addition, the droplets may be provided over a relatively wide particle size distribution. There are possible and foreseen variations of the subject system and method as disclosed herein. Accordingly, the specific structure disclosed and illustrated is not a reasonable limitation of the scope of the present disclosure and claims. The following describes certain preferred embodiments of the aeroponic system.

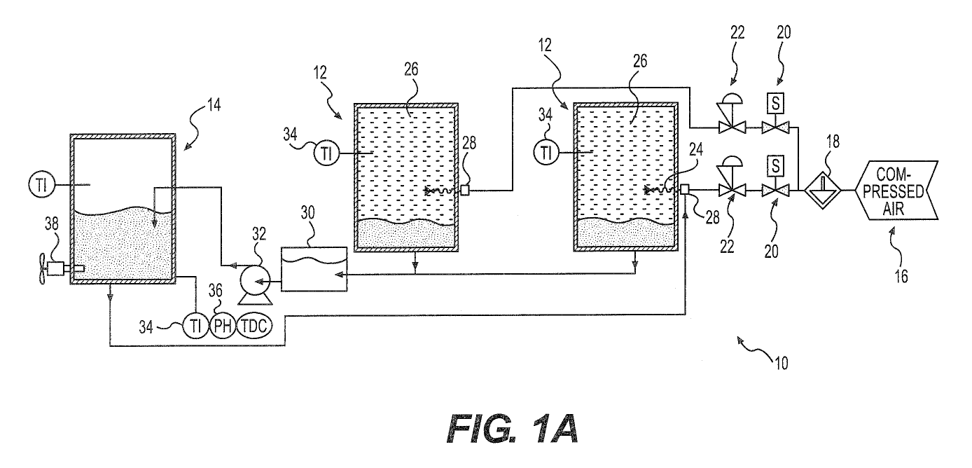

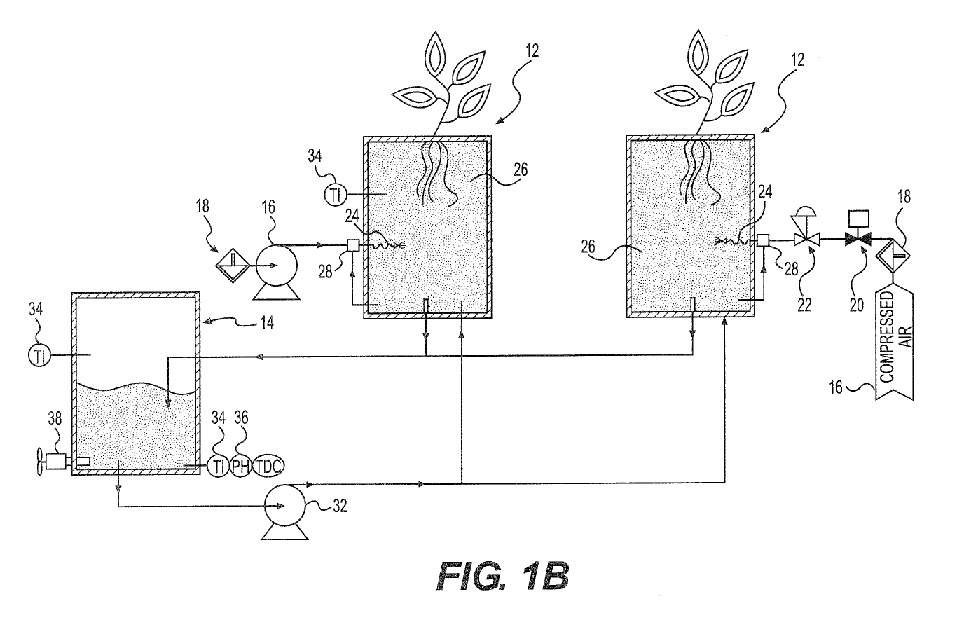

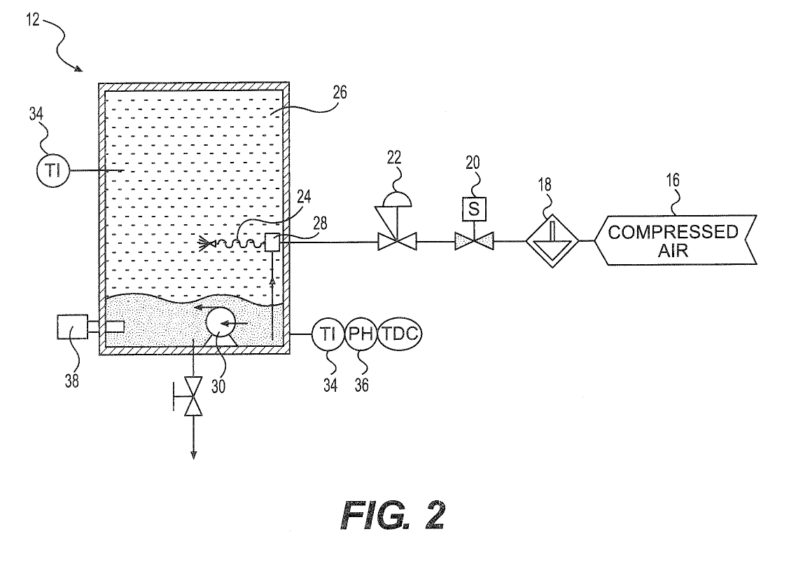

Turning now to a more detailed description of the present invention, there is illustrated in FIGS. 1A to 4 embodiments of the aeroponic system of the present disclosure. FIGS. 1A and 2 schematically illustrate the operation of the subject system.

More specifically, FIGS. 1A and 1B illustrate a multiple cell aeroponic system 10 in accordance with the subject disclosure. A multi-cell system will comprise a plurality of growing chambers 12 (at least two) per one or more central nutrient tanks 14. Multiple multi-cell systems could be combined for a large-scale operation.

A compressed gas generator 16 moves air through an optional air filter 18 as well as solenoid valves 20, a pressure regulator 22, and/or other controls to deliver pressurized air to a nozzle 24. Nozzle 24 injects the pressurized air into a root chamber 26.

A fluid junction 28 is fluidly connected in-line with the pressurized/compressed gas generator 16 and each nozzle 24. Each junction 28 is also fluidly connected to central nutrient tank 14, which stores water or nutrient fluid. The air moving through each junction 28 siphons fluid from the one or more central tanks 14. As will be described further below, each nozzle 24 is a dual fluid nozzle to introduce the air and fluid into the root chamber 26.

The lower portion of each chamber 26 may comprise a fluid reservoir capturing the water or nutrient fluid injected into the chamber. Each chamber has a drain whereby excess liquid is removed and recirculated through the system as well as an optional dump drain to empty the chamber for cleaning, transport, or the like. An optional return sump 30 and/or pump 32 draw the collected fluid in each chamber 26, if any, back to the central tank 14. Pump 32 may be located after tank 14 to draw fluid from chamber(s) 12 through tank 14. However, the fluid flow is low velocity and is mainly introduced to the nozzle through a low-pressure suction, as discussed further below.

The root chamber(s) and central tank(s) may be monitored by temperature indictor(s) 34, pH indicator(s) 36, and/or other devices used to monitor and control the conditions in the respective chambers/tanks. From these monitoring devices, the fluid can be maintained at a desired temperature by a water heater and/or cooler 38, which reduces or prevents certain plant diseases.

The fluid is circulated through the closed system and suitable conditions are maintained to reduce or prevent bacterial growth in the fluid. Another advantage of the subject multi-cell system is the ability to disengage and clean particular cells while continuing the operation of the overall system. Algae and fungus can, therefore, be removed without taking the system offline. Overall, the system can be expanded as the plants grow.

FIG. 2 better illustrates a single cell unit with integral sump. Here, the fluid is circulated within a single root chamber 26. In either embodiment nozzle 24, such as a sonic nozzle, siphons the liquid from a liquid reservoir via the negative pressure created by passing the compressed air through a venturi in the nozzle (see below). Most or all components are temperature controlled or insulated, and the fluid is circulated for mixing and temperature control in the root/aeroponic chamber. It is noted that each root chamber 12 is under a plant support deck. The deck contains a plurality of apertures through which a plant's roots pass. The deck may support many different size pots or different cells might be adapted for different size pots. Each cell could then support any number of plants at a time. Basically, the size of the system and size of the support deck may be customized depending on a particular end-user requirement.

The subject system grows plants by supporting them on a platform above an aeroponic chamber where the lower stem and/or roots hang unconstrained in the chamber. A liquid reservoir or supply may or may not occupy the bottom portion of the aeroponic chamber. The subject plant roots are not directly in contact with a liquid bath through most or all of the plants' life cycle. However, the deeper, larger roots, which are responsible for acquiring large volumes of liquid, would be allowed to attach to the walls and floor of the grow chamber so that the roots are constantly in contact with a film or a depth of liquid and never starved of moisture. The nozzle system of the subject system keeps those areas wet by producing a fraction of larger droplets that easily impact and deposit on the walls and floor of the root chamber.

In one embodiment, the grow chamber is designed with a means of supporting an internal structure that will cause the roots to spread, reducing the density of the root ball, and to provide additional vertical surface within the chamber for root irrigation.

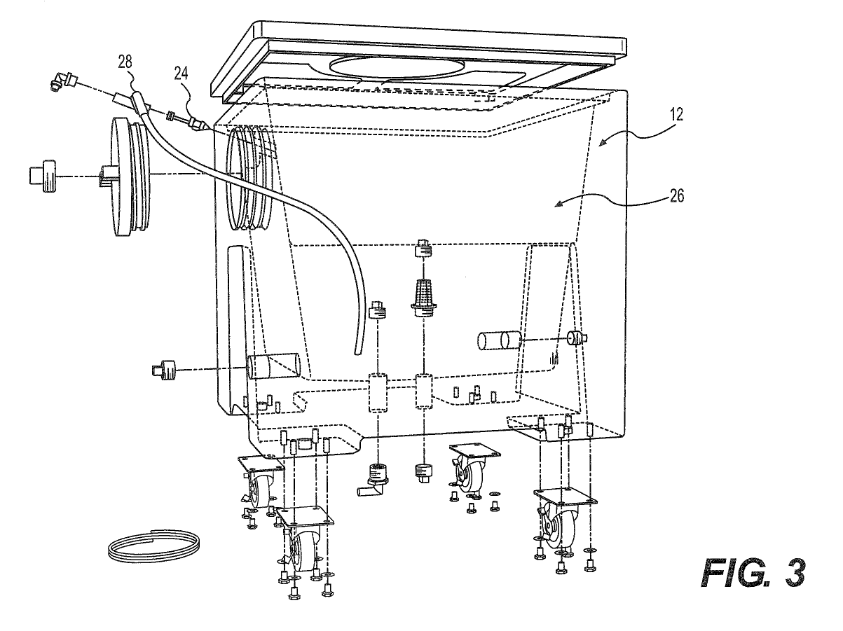

The construction of the chamber is better illustrated in FIG. 3. Chamber 12 includes an inlet for nozzle 24. Nozzle 24 is fluidly connected to junction 28 that, in turn, is fluidly connected to a source of pressurized gas and a fluid source for a plant nutrient rich fluid. Chamber 12 further includes a recycling drain for the fluid injected into the chamber via the nozzle and optional dump drain to remove the fluid for cleaning purposes. Components such as casters might be included if desired. Chamber 12 also includes apertures to fit and support sensors, as discussed herein, for monitoring the conditions within the chamber.

An insulation layer, such as a foam insulation layer, may be included. The insulation, in conjunction with a temperature-controlled liquid, will keep the root zone temperature at a desired level. During warmer months, the root zone will be cooler than ambient conditions. Since root pathogens can grow at higher temperatures, this will maximize plant yields. The insulation means little to no energy input is required to regulate liquid temperatures.

The very fine liquid droplets sprayed by the subject nozzle enhance the cooling effect of liquid evaporation (i.e., more surface area of droplets to evaporate). The system can also be operated intermittently so that evaporation occurs. In a continuous operation system, as is conventionally employed, there is no opportunity for evaporation.

The chamber of FIG. 3 illustrates a lone nozzle. However, in one direct spray embodiment, there may be provided any number of top, side, and bottom mounted spray nozzles. Basically, any number of nozzles may be employed to accommodate for the size of the aeroponic chamber, the age and thickness of the root bundles, the type of plant, atmospheric conditions, and the like. As such, the subject system will be provided in a range of sizes and configurations. It is also envisioned that modular arrangements for the system will be provided.

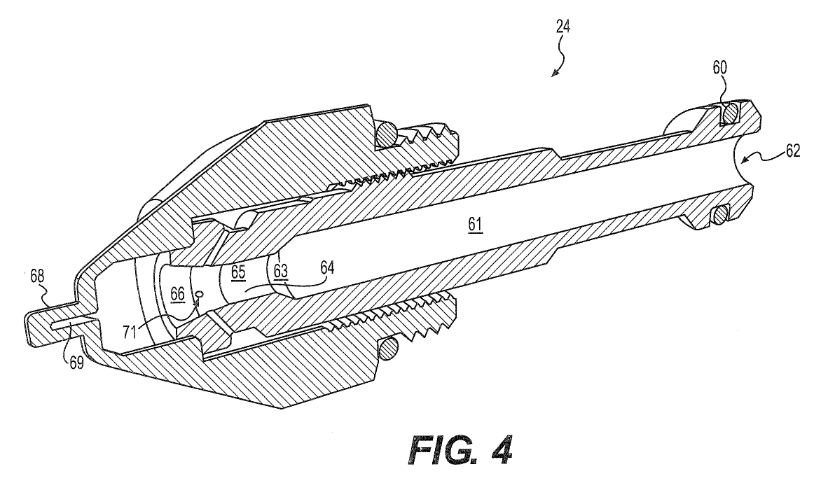

FIG. 4 provides a cutaway of one embodiment of a nozzle 24 for use with the subject system. The illustrated embodiment is a dual fluid (gas and liquid), sonic nozzle comprising a first o-ring 60 creating a hermetic seal between nozzle 24 and a conduit conveying pressurized air. The pressurized air from the conduit (not illustrated in FIG. 4) enters nozzle 24 via an air inlet 62. The airflow travels through a conduit 61 from inlet 62 to a venturi 64, which in this case is a decreasing diameter passage that accelerates the pressurized air to sonic velocities. Venturi 64 comprises a converging inlet section 63, a cylindrical section 65 having a diameter less than the diameter of inlet 62 and conduit 61, and a diverging venturi outlet 66. By venturi 64, the air (fluid) gains velocity and kinetic energy. Air velocity in section 65 is greater than Mach 1.

The nozzle is fed with the second fluid, a liquid, by a siphoning effect created by the nozzle. A pump or other means could create pressure to move the liquid as well, but the liquid is, in either event, fed at a low velocity to the nozzle. The fluid is fed around the outside of air inlet 62.

In further detail, the first fluid (e.g., air) exits venturi 64 via venturi outlet 66. The air (fluid) decelerates and a vacuum exists at outlet 66. Shock waves are created from the air decelerating from supersonic velocity to sonic velocity. The shockwaves are at least partially reflected by a resonator 68 comprising a resonator chamber 69. The reflected shockwaves cause constructive interference between the emitted and reflected waves. The sonic energy field is thereby amplified.

As disclosed above, nozzle 24 is fluidly connected to a liquid nutrient reservoir, which is either the aeroponic chamber or a central, shared tank. The water or nutrient rich fluid is introduced through one or more liquid ports 70 and corresponding fluid apertures 71 that are located downstream of the middle section 65. Port(s) 70 and fluid apertures 71 are located where the negative (vacuum) air pressure exists in the nozzle. Therefore, the nozzle causes suction on the liquid line. In this manner, the movement of air through nozzle 24 siphons the fluid into the nozzle.

It should be understood that the liquid is not introduced at a high velocity. That is, the hydraulic forces generated by siphoning the fluid via the pressurized air would not be enough, on their own, to atomize the liquid. Indeed, even if the pressure via a pump or other means were introduced to the liquid prior to the nozzle, the liquid velocity would not be enough to substantially atomize the liquid. As such, the nozzle does not include an impingement table or other physical structure that operates to atomize the fluid. The liquid enters the nozzle downstream of the venturi outlet at an angle less than perpendicular to the longitudinal axis of the nozzle. It is also envisioned that the aperture(s) 71 might be aligned perpendicular to the longitudinal axis of the nozzle, which effects atomization, forward spray throw, and cone-angle definition of the resulting spray.

Notably, the subject nozzle is free of any moving parts or electrical connections. In one embodiment, disengaging the gas pressure generator ceases the flow of liquid to the nozzle. Such a system is easy to control and relatively simple and economical to build, maintain and operate. The subject nozzle for aeroponics is connected to a gas and liquid nutrient source. It is not connected to a liquid (combustible) fuel.

The siphoned fluid enters the shockwave zone of the nozzle proximate to the constructive interference caused by the reflected shockwaves engaging the waves emitted from the venturi. The nutrient fluid or water is “shattered” by the shock waves. Sonic waves moving in multiple directions ensures that each droplet is further “shattered” and reduced in size before leaving the interference zone of the nozzle. The sonic forces atomize the fluid into droplets having a droplet size in a range of <1 to 50 (or more) micron(s) saunter mean diameters. Controlling the ratio of water flow to air pressure/air flow can independently control the droplet size.

As noted above, the subject system creates a fog using a dual fluid-type nozzle (air and liquid) that uses a compressed gas, such as air, to atomize liquid that is aspirated directly from the bath of nutrient rich liquid circulating through the bottom of the aeroponic chamber. In another embodiment, it is envisioned that the liquid might be aspirated or pumped from a central storage tank.

By the subject nozzle and system, atomization of the liquid is more versatile and controllable than conventional atomization including atomization via piezoelectric nozzles. Smaller droplet sizes can be achieved relative to conventional aeroponic systems. At the same time, a broader distribution of droplet particle sizes can be achieved by the apparatus and methods disclosed herein.

The subject system also contemplates enriching the compressed gas with extra oxygen, carbon dioxide, or other component to accelerate growth in certain plants. The atomizing gas can include a desired additive component.

The system can have many forms. For example, in one embodiment, the nozzle presents droplets directly into the root aeroponic chamber (i.e., “direct spray”). In another embodiment, the fog may first enter a fog chamber and then a portion of the generated fog would be delivered to the aeroponic chamber through one or more conduits that may or may not be fitted with fans. The fans would further control droplet size distribution or would assist in distributing the droplets into complex root structures.

It has surprisingly been found that continuous fog or droplet generation in an aeroponic system is not necessary to maximize plant growth. Instead, intermittent operation of a droplet-producing nozzle in an aeroponic system can encourage growth. Moreover, the intermittent operation allows for evaporation of the water/nutrient source in the chamber. The evaporation reduces temperatures within the optionally insulated chamber to create conditions less suitable for plant diseases. The alternating wet/dry environment is beneficial to plant degassing without starving other roots of moisture.

Although the present invention has been described in terms of one or more preferred embodiments, it will be understood that numerous variations and modifications may be made without departing from the invention. Thus, for example, the material or ornamental design of the system can be varied without leaving the scope of the disclosed invention. Additional embodiments and uses of the system will become apparent to one skilled in the art. Thus, it is to be understood that the invention may be practiced otherwise than as specifically described above.

What is claimed is:

1. An aeroponic, plant growing system comprising:
an aeroponic chamber comprising a plant support deck and a drain, the deck defining a plurality of apertures through which at least one plant's roots pass;
a compressed gas generator;
a source of liquid plant nutrient;
a nozzle for injecting air from the compressed gas generator and the liquid nutrient into the aeroponic chamber, the nozzle comprising a first fluid inlet for conveying the air, a conduit from the first inlet to a venturi, an outlet, and at least one second fluid inlet comprising a fluid aperture, the venturi comprising a converging section, a cylindrical section, and a diverging section, the at least one second fluid inlet that comprises a fluid aperture located in the diverging section;
a plurality of shock waves generated via the nozzle; and
the liquid plant nutrient fed to the nozzle via the at least one second fluid inlet,
the liquid plant nutrient atomized via the shock waves, the atomized liquid comprising a distribution of liquid droplet sizes in the range of 1 to 100 micron saunter mean diameter, and the atomized fluid delivered to the chamber and the at least one plant's roots via the nozzle and an airflow generated by the compressed gas generator.

2. The system of claim 1 wherein the operation of the system is intermittent and not continuous.

3. The system of claim 1 further comprising a volume of fluid stored in the aeroponic chamber.

4. The system of claim 1 further comprising a central nutrient tank containing the source of liquid plant nutrient; a pump; and the pump, aeroponic chamber and central nutrient tank fluidly connected.

5. The system of claim 1 wherein the nozzle further comprises a resonator; a plurality of reflected shock waves generated via the resonator; and a standing wave pattern of sonic energy generated via the constructive interference between the shock waves generated by the nozzle and the reflected shock waves.

6. A method of aeroponic cultivation comprising:
providing an aeroponic chamber including a plant root ball and a nozzle, the nozzle comprising a first fluid inlet for conveying air, a conduit from the first inlet to a venturi, an outlet, and at least one second fluid inlet comprising a fluid aperture, the venturi comprising a converging section, a cylindrical section, and a diverging section, the at least one second fluid inlet that comprises a fluid aperture located in the diverging section;
supplying a flow of compressed air to the first fluid inlet;
generating shockwaves via the nozzle venturi;
further supplying a flow of liquid plant nutrient to the at least one second fluid inlet;
atomizing the liquid nutrient via the shockwaves; and
carrying the atomized liquid nutrient to the plant root ball via the flow of air.

7. The method of claim 6, further comprising the step of adjusting the flow of compressed air to the nozzle to vary the volume of atomized liquid nutrient carried to the plant root ball.

8. The method of claim 6, further comprising the step of intermittently stopping the flow of liquid plant nutrient supplied to the nozzle.

9. The method of claim 6, further comprising enriching the flow of compressed air with additional oxygen.

10. The method of claim 6, wherein the step of atomizing the liquid nutrient via the shockwaves comprises atomizing the liquid nutrient to a distribution of liquid droplet sizes in the range of 1 to 100 micron saunter mean diameter.

11. The method of claim 10, wherein the step of the step of atomizing the liquid nutrient via the shockwaves comprises atomizing the liquid nutrient to a distribution of liquid droplet sizes in the range of 1 to 50 micron saunter mean diameter.

12. The method of claim 11, wherein the step of the step of atomizing the liquid nutrient via the shockwaves comprises atomizing the liquid nutrient to a distribution of liquid droplet sizes in the range of 5 to 30 micron saunter mean diameter.

13. The method of claim 6, further comprising the steps of altering the ambient temperature of the liquid plant nutrient.

14. An aeroponic apparatus comprising:
an aeroponic chamber comprising a plant support deck, a drain, and a nozzle, the deck defining a plurality of apertures through which at least one plant's roots pass, the nozzle for injecting air and a liquid nutrient into the aeroponic chamber, the nozzle comprising a first fluid inlet for conveying the air, a conduit from the first inlet to a venturi, an outlet, and at least one second fluid inlet comprising a fluid aperture, the venturi comprising a converging section, a cylindrical section, and a diverging section, the at least one second fluid inlet that comprises a fluid aperture located in the diverging section;
a plurality of shock waves generated via the nozzle; and
a flow of liquid plant nutrient introduced to the shockwaves via the nozzle at the at least one second fluid inlet, the liquid plant nutrient atomized via the shock waves, the atomized liquid comprising a distribution of liquid droplet sizes in the range of 1 to 100 micron saunter mean diameter.
